(19) United States
(12) Patent Application Publication
(10) Pub. No.: US 2023/0284695 A1
(43) Pub. Date: Sep. 14, 2023

(54) APPARATUS FOR HEATING AEROSOLISABLE MATERIAL

(71) Applicant: NICOVENTURES TRADING LIMITED, London (GB)

(72) Inventors: Mitchel THORSEN, Madison, WI (US); Luke WARREN, London (GB); Nicholas ROSSER, London (GB); leuan Matthew CARNEY, London (GB); Juan Esteban PAZ JAUREGUI, London (GB)

(21) Appl. No.: 18/002,981

(22) PCT Filed: Jun. 25, 2021
(86) PCT No.: PCT/EP2021/067561

§ 371 Date: Dec. 22, 2022

(30) Foreign Application Priority Data
Jun. 26, 2020 (US) 62705428

(51) Int. Cl. A24F 40/46; A24F 40/20; A24D 1/20; H05B 3/42

(52) U.S. Cl. CPC A24F 40/46; A24F 40/20; A24D 1/20; H05B 3/42

(57) ABSTRACT

Apparatus arranged to heat aerosolizable material to volatize at least one component of the aerosolizable material. The apparatus comprises a conductive wire arranged to generate heat for transfer to the aerosolizable material in response to application of an electric current. The conductive wire has a resistivity between 0.9 ohm·mm2/m and 1.6 ohm·mm2/m.

### CROSS-REFERENCE TO RELATED APPLICATIONS

The present application is a US National Stage entry of PCT Application no. PCT/EP2021/067561, filed Jun. 25, 2021, which claims priority to U.S. Provisional Application No. 62/705,428, filed Jun. 26, 2020, and which applications are incorporated herein by reference.

### TECHNICAL FIELD

The present disclosure relates to an apparatus arranged to heat aerosolizable material.

### BACKGROUND

Articles such as cigarettes, cigars and the like burn tobacco during use to create tobacco smoke. Attempts have been made to provide alternatives to these articles, which burn tobacco, by creating products that release compounds without burning. Examples of such products are so-called heat-not-burn products, also known as tobacco heating products or tobacco heating devices, which release compounds by heating, but not burning, the material. The material may be for example tobacco or other non-tobacco products or a combination, such as a blended mix, which may or may not contain nicotine.

### SUMMARY

According to a first aspect of the present disclosure, there is provided an apparatus arranged to heat aerosolizable material to volatise at least one component of the aerosolizable material, the apparatus comprising:
a conductive wire arranged to generate heat for transfer to the aerosolizable material in response to application of an electric current, wherein the conductive wire has a resistivity between 0.9 ohm·mm²/m and 1.6 ohm·mm²/m.

In an exemplary embodiment, the apparatus further includes a receiving portion arranged to receive a consumable comprising the aerosolizable material, and wherein the conductive wire is disposed around the receiving portion.

In an exemplary embodiment, the receiving portion is a tube arranged to receive a cylindrical consumable article comprising the aerosolizable material.

In an exemplary embodiment, the conductive wire is arranged in a helix around the receiving portion.

In an exemplary embodiment, the conductive wire comprises one or more zones including a first zone and a second zone, the first zone extending from a distal end to an intermediate portion, and the second zone extending from the intermediate portion to a proximal end.

In an exemplary embodiment, the apparatus is a consumable article comprising a backing sheet, wherein the conductive wire is applied to the backing sheet, and wherein the aerosolizable material is provided on the conductive wire.

In an exemplary embodiment, the conductive wire includes an electric current inlet, a central portion and an electric current outlet.

In an exemplary embodiment, the aerosolizable material is provided on the central portion.

In an exemplary embodiment, the backing sheet is formed from card or paper.

In an exemplary embodiment, the central portion is a disc shape, and wherein the aerosolizable material is a disc shape.

In an exemplary embodiment, the conductive wire includes an electric current inlet, a receiving portion and an electric current outlet.

In an exemplary embodiment, the receiving portion is adapted to receive a consumable comprising the aerosolizable material.

In an exemplary embodiment, the receiving portion is disc shape.

In an exemplary embodiment, the conductive wire is formed of at least one of Fecralloy®, nichrome, Alkrothal®, Kanthal® and/or Nikrothal®.

### BRIEF DESCRIPTION OF THE DRAWINGS

Embodiments of the disclosure will now be described, by way of example only, with reference to the accompanying drawings, in which:

FIG. 1 shows a schematic cross-sectional view of an example of an apparatus for heating an aerosolizable material to volatise at least one component of the aerosolizable material;

FIG. 2a shows a schematic cross-sectional view of an example of a conductive wire;

FIG. 2b shows a schematic cross-sectional view of an example of a conductive wire;

FIG. 3 shows a schematic cross-sectional view of an example of an apparatus for heating an aerosolizable material to volatise at least one component of the aerosolizable material;

FIG. 4 shows a schematic cross-sectional view of an example of an apparatus for heating an aerosolizable material to volatise at least one component of the aerosolizable material;

FIG. 5 is a schematic diagram showing an example of an apparatus according to an embodiment of the disclosure;

FIG. 6a shows an example of a single turn configuration of conductive wire;

FIG. 6b shows an example shape of a conductive wire;

FIG. 7 shows an example external support for use with the disclosure;

FIG. 8a shows an example of a two turn configuration of conductive wire;

FIG. 8b shows an example of a three turn configuration of conductive wire;

FIG. 9 shows an example electric trace;

FIG. 10 shows an example receiving portion;

FIG. 11 shows another example receiving portion;

FIG. 12 shows an example of a consumable to be used within a tobacco heating device; and

FIG. 13 shows an example of a removable consumable and a trace within a tobacco heating device.

### DETAILED DESCRIPTION

Apparatus is known that heats aerosolizable material to volatilise at least one component of the aerosolizable material, typically to form an aerosol which can be inhaled, without burning or combusting the aerosolizable material. Such apparatus is sometimes described as a “heat-not-burn” apparatus or a “tobacco heating product” or “tobacco heating device” or similar. Similarly, there are also so-called e-cigarette devices, which typically vaporise an aerosolizable material in the form of a liquid, which may or may not contain nicotine. In general, the aerosolizable material may be in the form of or provided as part of a rod, cartridge or cassette or the like which can be inserted into the apparatus. A heating material for heating and volatilising the aerosolizable material may be provided as a “permanent” part of the apparatus or may be provided as part of the consumable article which is discarded and replaced after use. A “consumable article” in this context is a device or article or other component that includes or contains in use the aerosolizable material, which in use is heated to volatilise the aerosolizable material.

As used herein, the term “aerosolizable material” includes materials that provide volatilised components upon heating, typically in the form of vapour or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenised tobacco or tobacco substitutes. The aerosolizable material may be in the form of ground tobacco, cut rag tobacco, extruded tobacco, reconstituted tobacco, reconstituted aerosolizable material, liquid, gel, gelled sheet, powder, or agglomerates, or the like. “Aerosolizable material” also may include other, non-tobacco products, which, depending on the product, may or may not contain nicotine. “Aerosolizable material” may comprise one or more humectants, such as glycerol or propylene glycol.

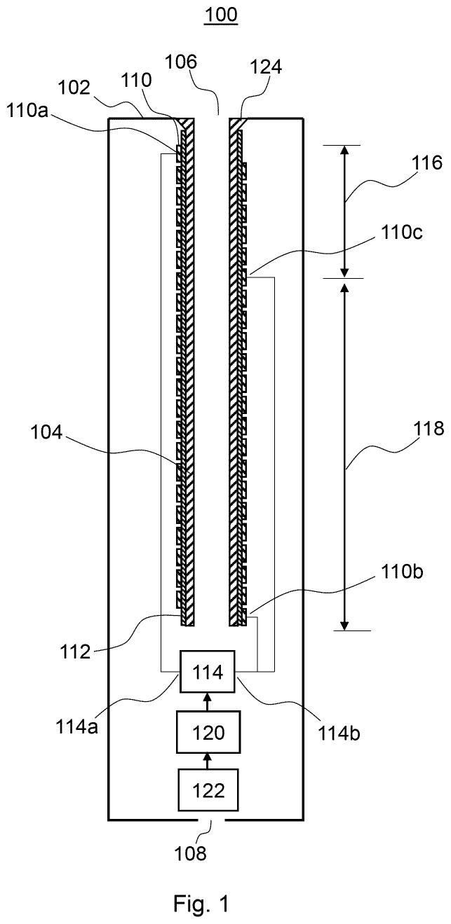

Referring to FIG. 1 there is shown a schematic cross-sectional view of an example of apparatus according 100 to an embodiment of the disclosure. The apparatus 100 is for heating aerosolizable material to volatilise at least one component of the aerosolizable material.

The apparatus 100 comprises an apparatus housing 102, referred to hereinafter as a body 102. The body 102 comprises a receiving portion 104 for receiving at least a portion of a consumable article comprising aerosolizable material that is to be heated.

The apparatus 100 has an outlet 106 to permit volatilised components of the aerosolizable material to pass from the receiving portion 104 towards an exterior of the apparatus 100 when the consumable article is heated in use.

The apparatus 100 has an air inlet 108 that fluidly connects the receiving portion 104 with the exterior of the apparatus 100. A user may be able to inhale the volatilised component(s) of the aerosolizable material by drawing the volatilised component(s) from the consumable article. As the volatilised component(s) are removed from the consumable article, air may be drawn into the receiving portion 104 via the air inlet 108 of the apparatus 100.

In this embodiment, the receiving portion 104 is cylindrical (i.e. circular in cross-section) and forms a recess or cavity for receiving at least a portion of the consumable article. The receiving portion 104 may have a diameter in the range 5 to 10 mm. In this embodiment, the receiving portion 104 comprises a flared opening 124.

The receiving portion 104 may be made from a metallic material such as aluminium, copper, manganin, steel, constantan, nichrome, stainless steel, nickel and Fecralloy®. In this embodiment, the receiving portion 104 is of tubular construction arranged to receive a consumable article having a cylindrical form. However, in other embodiments, the receiving portion 104 may be arranged to receive consumable articles having other forms (i.e. non-cylindrical) and may accordingly have other geometries arranged to receive such consumable articles. For example, the receiving portion 104 may have a rectangular cross-section. In other embodiments, the receiving portion 104 may be other than a recess, such as a shelf, a surface, or a projection, and may require mechanical mating with the consumable article in order to co-operate with, or receive, the consumable article. In this embodiment, the receiving portion 104 is elongate, and is sized and shaped to accommodate a portion of the consumable article such that a further portion of the consumable article protrudes from the body 102. In other embodiments, the receiving portion 104 may be dimensioned to receive the whole of the consumable article. In many embodiments, the receiving portion 104 has a wall thickness in the range 0.05 to 0.15 mm. For example, the receiving portion 104 may be a tube having a wall thickness of approximately 0.1 mm.

Around the receiving portion 104 is a conducive wire 110 arranged to generate heat in response to an applied electric current by resistive heating. The conductive wire 110 may take any suitable form. In this embodiment the conductive wire 110 is a coil of electrically conductive wire wrapped around the receiving portion 104 in a helical arrangement. The coil extends along a longitudinal axis that is substantially aligned with a longitudinal axis of the receiving portion 104.

Each turn of the coil is electrically isolated from adjacent turns. In this embodiment, each turn of the coil is separated from adjacent turns by an air gap. In some embodiments, the coil may be encapsulated in a dielectric material. Electrical isolation of the turns of the coil from adjacent turns prevents short circuits between the turns of the coil, which would otherwise affect the resistance of the coil and alter the heating characteristics of the conductive wire 110.

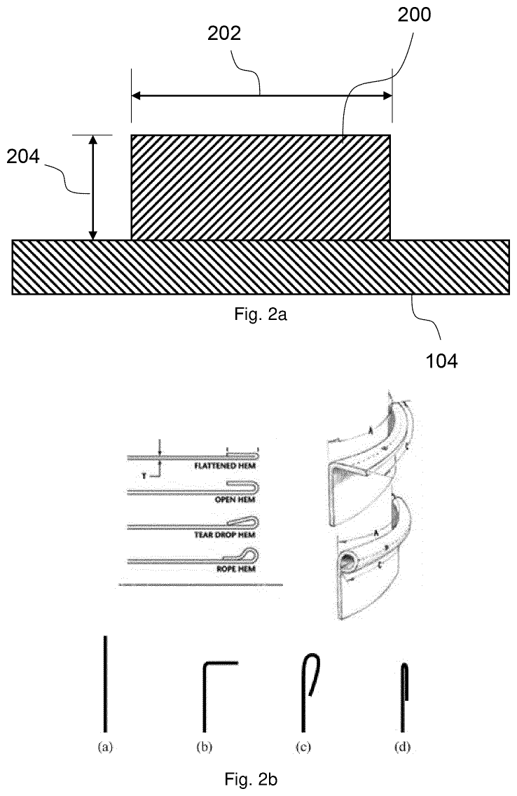

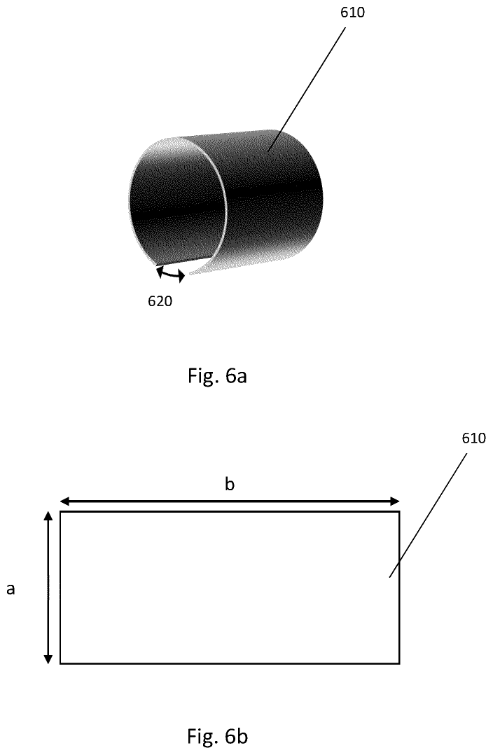

FIG. 2a shows a schematic cross-section of a wire 200 from which the conductive wire 110 may be formed to cooperate with the receiving portion 104. In this embodiment the wire 200 may be drawn or otherwise formed to have a substantially rectangular cross-section. As would be appreciated, a substantially rectangular cross section may encompass other artefacts, such as ones that are present from manufacturing, as long as a substantially rectangular cross section of the wire contacts the receiving portion 104. For example, the wire may have a C or L shaped cross section, or alternatively, any of the cross sections seen in FIG. 2b, such as a flattened hem, open hem, tear drop hem or rope hem. Such artefacts may be present on either side. In particular, the wire 200 has a width 202 and a thickness 204. In some embodiments, the width 202 of the wire is in the range of 2.75 mm±30% to 5.95 mm±30%. In some embodiments, the thickness of the wire is in the range of 0.05 mm±30% to 0.1 mm±30%. The wire may also be thinner, with a range of 0.01 mm±30% to 0.1 mm±30%. In other embodiments, such as a single turn embodiment as shown in FIGS. 6a and 6b (discussed further below), the wire may be wider, such as up to 20 mm±30% such that a single turn may cover the entire receiving portion 104. With respect to wires having a non-rectangular cross-section (e.g. wires having a circular cross-section), the wire 200 provides an increased area which is in contact with the receiving portion 104, and consequently provides an improved thermal transfer of heat between the wire 200 and the receiving portion 104. An increased area of contact between the wire 200 and the receiving portion 104, and the consequential improvement of thermal contact between the wire 200 and the receiving portion 104, provides improved heat transfer between the wire 200 and the receiving portion 104 and therefore improves the heating efficiency of the apparatus 100. Accordingly, a wire having the dimensions of the wire 200 described with reference to FIG. 2 may reduce (i.e. improve) the time taken for the conductive wire 110 to reach a desired temperature.

Once applied within the apparatus (i.e. wound around the receiving portion 104), the substantially rectangular form of the wire may deform so that its rectangular cross-section conforms with an outer surface of the receiving portion 104. For example, a lower face 206 may conform to a radius of an outer surface of the receiving portion 104 and an outer face 208 may accordingly deform to correspond with a radius defined by the radius of the receiving portion 104. In embodiments where the conductive wire 200 forms a helix, the conductive wire 200 may deform to form compound curves i.e. one conforming to a curve in an axis parallel to the longitudinal axis of the receiving portion 104 and one conforming to a curve in an axis perpendicular to the longitudinal axis of the receiving portion 104.

In this embodiment, the conductive wire 110 extends along substantially the whole length of the receiving portion 104. However, in other embodiments, the conductive wire 110 may extend along only a part of the receiving portion 104 (i.e. not along the full length of the receiving portion 104).

An outer surface of the receiving portion 104 comprises an insulating layer 112 to provide electrical isolation between the conductive wire 110 and the receiving portion 104. The insulating layer 112 may, for example, comprise a dielectric material. In some embodiments, the insulating layer 112 may be adhered to the outside surface of the receiving portion 104; for example, the insulating layer 112 may be a layer of polyimide film adhered to the outer surface of the receiving portion 104. In other embodiments, the insulating layer 112 may be an oxidation layer formed on the outer surface of the receiving portion 104; for example, the receiving portion 104 may be formed of a metal material and the insulating layer 112 may be formed of an oxide of that metal. In one example, the receiving portion 104 may be formed of aluminium and the insulating layer 112 may be an anodised layer formed of aluminium oxide. In some examples, the anodised layer may be formed by a process of so-called hard anodization.

In this embodiment, the conductive wire 110 is wrapped around the insulating layer 112 supported on the receiving portion 104. Resilience provided by the material from which the conductive wire 110 is made may provide a compressive force to hold the conductive wire 110 in contact with the insulating layer 112 on the surface of the receiving portion 104, thus improving thermal contact between the conductive wire 110 and the receiving portion 104. Alternatively, or additionally, a further component, e.g. an additional tube or one or more resilient members such as spring clips, may be arranged around the conductive wire 110 to hold it in place on the receiving portion 104. For example, there may be provided a sleeve around the conductive wire 110, in order to physically retain the conductive wire 110 in contact with the receiving portion 104 to improve the thermal contact between the conductive wire 110 and the receiving portion 104, such as a heat shrink sleeve. One such material may be PEEK heat shrink. Additionally or alternatively, other systems for maintaining tension in the conductive wire wrap so as to ensure good contact between the conductive wire 110 and the receiving portion 104 may be utilised. For example, a friction based tension system may be used.

In other embodiments, the conductive wire 110 may comprise an electrical trace formed between layers of dielectric material. For example, the electrical traced may be an etched trace formed between sheets of polyimide.

In some embodiments, the receiving portion 104 may be defined by the conductive wire 110 itself. That is, there may be no separate receiving portion 104 between the conductive wire 110 and the space in which a consumable article is to be received. For example, outward facing surfaces of the conductive wire 110 (e.g. a coil) may be supported and/or mounted on an internal surface of a support structure, such that the conductive wire 110 and the support structure form a heating chamber without the need for a separate, thermally conductive, internal support. Such an embodiment may improve the transfer of heat energy from the conductive wire 110 to aerosolizable material in a received consumable article. In some embodiments, the support structure may be made of a plastics material capable of withstanding temperatures necessary to volatise one or more components of the aerosolizable material. For example, the support structure may comprise polyether ether ketone (PEEK).

Although in the embodiment shown in FIG. 1, the conductive wire 110 is arranged in a coil, in other embodiments the conductive wire 110 may have other arrangements; for example, the conductive wire 110 may be arranged in a “zig-zag” pattern extending along a longitudinal axis of the receiving portion 104.

The conductive wire 110 may be formed of any suitable material. In some embodiments, the conductive wire 110 is formed of a metal material; for example, the conductive wire 110 may include one or more of: aluminium, copper, manganin, steel, constantan, nichrome, stainless steel, nickel and Fecralloy®, which is an alloy of iron, chrome and aluminium that has relatively high resistivity for a conductor and can ramp up to a target temperature relatively quickly. In other embodiments, the conductive wire 110 may be formed of a ceramics material.

The apparatus 100 also comprises an electrical power source 114 for applying an electric current to the conductive wire 110 in use. In response to an applied electric current, resistive heating of the conductive wire 110 causes the temperature of the conductive wire 110 to increase. The electrical power source 114 of this embodiment is a rechargeable battery. In other embodiments, the electrical power source 114 may be other than a rechargeable battery, such as a non-rechargeable battery, a capacitor, a battery-capacitor hybrid, or a connection to an external power supply, such as a mains electricity supply or a USB powered electrical supply.

A first terminal 114a of the electrical power source 114 is electrically connected to a first end 110a of the conductive wire 110. A second terminal 114b of the electrical power source 114 is electrically connected to a second end 110b of the conductive wire 110. In this embodiment, an electrical connection is also made between the second terminal 114b of the electric power source 114 and an intermediate point 110c on the conductive wire 110 between the first end 110a and the second end 110b. Such an arrangement of electrical connections permits application of electrical power to different zones of the conductive wire 110. In particular, in this embodiment, a first zone 116 (referred to herein as Zone 1) is defined between the first end 110a and the intermediate point 110c between the first end 110a and the second end 110b, and a second zone 118 (referred to herein as Zone 2) is defined between the second end 110b and the intermediate point 110c between the first end 110a and the second end 110b. In other embodiments, the conductive wire 110 may be electrically connected to the electric power source 114 to define a single zone or may be electrically connected to the electric power source 114 to define more than two zones. The zones may be of substantially equal length or of different lengths to provide different heating characteristics in different heating zones. In some embodiments, Zone 1 116 extends along the conductive wire 110 (and therefore the receiving portion 104) for a length in the range 10 to 20 mm and Zone 2 118 extends along the conductive wire 110 (and therefore the receiving portion 104) for a length in the range 25 to 30 mm. In the embodiment shown in FIG. 1, Zone 1 116 extends along the conductive wire 110 (and therefore the receiving portion 104) for a length in the range 14 to 16 mm and Zone 2 118 extends along the conductive wire 110 (and therefore the receiving portion 104) for a length in the range 27 to 28 mm. In addition to the above, it is desirable that the conductive 110 is connected to the electrical power source 114 such that each of the one or more zones may be independently operable. For example, in the embodiment of FIG. 1, if desired, then only Zone 1 116 may be heated, or only Zone 2 118 may be heated, or both Zones may be heated together. This is equally applicable to any length of Zone and/or length of receiving portion 104, or any number of Zones.

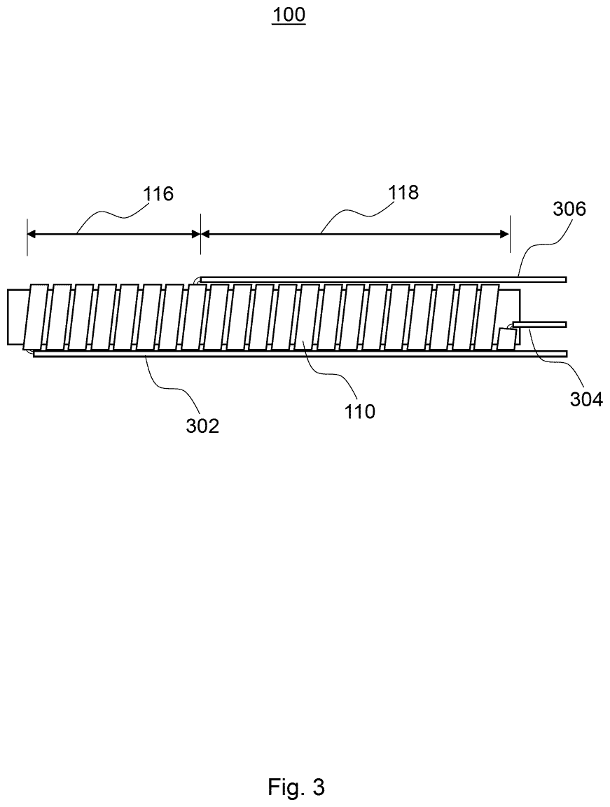

FIG. 3 is a schematic diagram showing a perspective view of the apparatus 100 with the conductive wire 110 wound around the receiving portion 104. In particular, FIG. 3 shows a first wire 302 (which is connected to the electric power source) connecting to the first end 110a of the conductive wire 110, a second wire 304 (which is connected to the electric power source) connecting to the second end 110b of the conductive wire 110 (to define Zone 1 116), and a third wire 306 (which is connected to the electric power source) connecting to the intermediate point 110c of the conductive wire 110 (to define Zone 2 118).

The rate at which the temperature of the conductive wire 110 increases depends upon the power applied to the conductive wire 110 and the resistance of the conductive wire 110. In embodiments in which the electrical power source 114 is a rechargeable battery, the voltage provided by the battery is typically a minimum of approximately 2.7 Volts, but may be up to a voltage of 4.2 Volts, and can deliver and electrical current of up to a maximum of approximately 8.6 Amps. Accordingly, the maximum power that can be supplied by such a rechargeable battery is typically approximately 23 Watts. Therefore, a target resistance for the conductive wire 112 when powered by such a rechargeable battery may be approximately 0.32 Ohms (0.35 Ohms±5%). The target resistance may be in the range of 0.31 Ohms±5% to 1 Ohm±5%. Such a resistance enables the temperature of the conductive wire 110 to increase from room temperature (i.e. approximately 23° C.) to a target temperature of approximately 280° C. in approximately three seconds (the ‘ramp up’ time); i.e. at a rate of approximately 90° C. per second, which is comparable with heating rates of inductive wires arranged to heat consumable article comprising aerosolizable material.

The resistance of the conductive wire 110 is dependent on the resistivity of the material. Lower density materials have a lower mass and therefore require less energy and/or time to heat. Similarly, materials having a lower specific heat require less energy and/or time to heat. However, since density is inversely proportional to specific heat, both cannot be selected to be low and a balance must be found.

Regarding resistivity of the material, a balance must be found between the energy and/or time required to heat and the coverage of a surface that is to be heated. Higher resistivity materials require less material and therefore have a lower mass (and therefore require less energy and/or time to heat) but cover less of the surface to be heated, whereas lower resistivity materials require more material and therefore have a higher mass (and therefore require more energy and/or time to heat) but cover more of the surface to be heated.

With a target temperature rise of approximately 257° C., a maximum available power of approximately 23 Watts, the time taken to reach the desired temperature for a given volume of material, tᵥ (having units of s/mm³), can be calculated for different materials using the equation:

tᵥ=(Temperature Rise×Specific Heat×Density)/Power

A controller 120 also is electrically connected to the electrical power source 114. The controller 120 is for controlling the supply of electrical power from the electric power source 114 to the conductive heater 110. The controller 120 may, for example, comprise an integrated circuit (IC), such as an IC on a printed circuit board (PCB).

The controller 120 is operated by user-operation of a user interface 122. The user interface 122 is located at the exterior of the body 102. The user interface 122 may, for example, comprise a push-button, a toggle switch, a dial, a touchscreen, or the like. In other embodiments, the user interface 122 may be remote and connected to the rest of the apparatus wirelessly, such as via Bluetooth.

Operation of the user interface 122 by a user causes the controller 120 to enable the electrical power source 114 to pass an electrical current through the conductive heater 110, so as to cause the conductive heater 110 to generate heat by resistive heating.

In some examples, in use, the apparatus 100 is configured so that the conductive wire 110 heats the first zone 116 to a first zone target temperature and the second zone 118 to a second zone target temperature. The first zone 116 target temperature may be in the range of between about 240° C. and about 300° C., such as between about 250° C. and about 280° C. Likewise, the second zone 118 target temperature may also be in the range of between about 240° C. and about 300° C., such as between about 250° C. and about 280° C. In some examples, the apparatus 100 is configured so that the conductive wire 110 first heats the first zone 116 to the first zone target temperature and then later heats the second zone 118 to the second zone target temperature (or vice versa).

In some examples, in use, the apparatus 100 is configured so that the conductive wire 110 heats the first zone 116 to the first zone target temperature in a ramp up time of between 2 to 40 seconds, such as between 2 to 10 seconds, for example 2 to 5 seconds. Likewise, in use, the apparatus 100 is configured so that the conductive wire 110 heats the second zone 118 to the second zone target temperature in a ramp up time of between 2 to 40 seconds, such as between 2 to 10 seconds, for example 2 to 5 seconds.

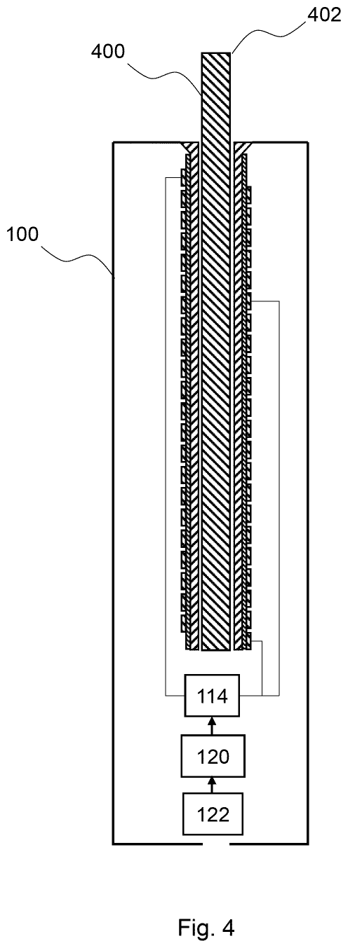

FIG. 4 shows an apparatus 100, as described above with reference to FIG. 1, in use with a consumable article 400 inserted into the receiving portion 104. As described above, the consumable article 400 may be inserted into the apparatus 100 to be heated to release (i.e. volatise) components present in aerosolizable material present in the consumable article 400. An end 402 of the consumable article 400 may, in some embodiments act as a mouthpiece from which volatised components from the aerosolizable material may be drawn.

When a consumable article is present in the receiving portion 104, and the controller 120 controls the electric power source 114 to pass an electric current through the conductive wire 110, heat from the conductive wire 110 heats the aerosolizable material to volatise components of the aerosolizable material.

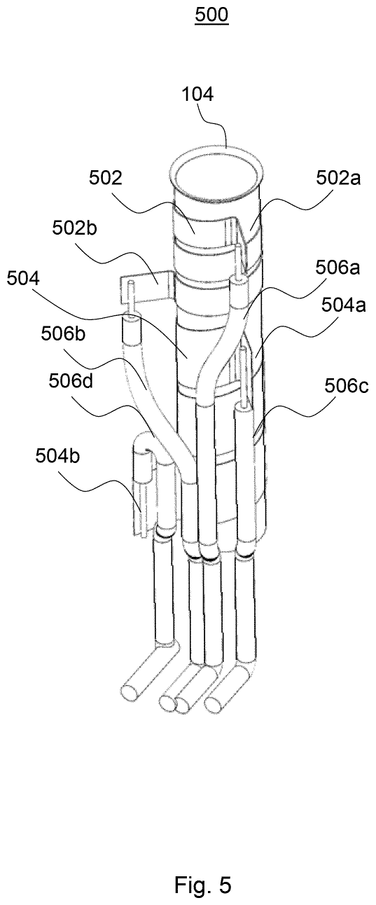

FIG. 5 is a perspective view of another example of apparatus 500 according to an embodiment of the disclosure. The apparatus shown in FIG. 5 is similar to the apparatus shown in FIG. 3 but includes multiple coils to define different heating zones; in this example a first coil 502 and a second coil 504.

The first coil 502 has a first end 502a and a second end 502b that are electrically connected (e.g. by a crimp joint or solder joint) to a first power wire 506a and a second power wire 506b respectively. Similarly, the second coil 504 has a first end 504a and a second end 504b that are electrically connected (e.g. by a crimp joint or solder joint) to a first power wire 506c and a second power wire 506d respectively. Each of the first and second coils 502, 504 are wrapped in a helical arrangement around the receiving portion 104. Each of the power wires 506a-506d may comprise a conductive core covered with an electrically insulating sheath. In some examples the insulating sheath may be formed from polyether ether ketone (PEEK).

In use the first coil 502 is arranged to heat a first heating zone of the receiving portion 104 and the second coil 504 is arranged to heat a second zone of the receiving portion 104. The first heating zone may extend from a distal end of the receiving portion 104 to a boundary point along the receiving portion 104, and the second heating zone may extend from the boundary point to a proximal end of the of the receiving portion 104. In some examples, the first heating zone extends by a length in the range 10 to 15 mm. In some examples, the second heating zone extends by a length in the range 20 to 30 mm.

In this example the second coil 504 is wider than the first coil 502 which can facilitate a different heating profile of the second coil 504. For example, it may be desirable that the second coil has a more or less rapid heating profile than the first coil. A wider coil may result in slower heating.

The ends of the first and second coils comprise tabs that provide space on which to form an electrical connection (for example, via a crimp joint or solder joint) with a power source via power wires 506a-506d.

The conductive wire may be provided with any number of turns in order to provide its function. For example, the conductive wire form a single turn around a receiving portion to provide a cylindrical element, as seen in FIG. 6a. In this way, the conductive wire 610 may be formed of a single sheet that is configured to wrap around the receiving portion, such as receiving portion 104 described above. As can be seen in FIG. 6b, the conductive wire 610 may therefore be provided with a simple shape such as a rectangle or a square with a given thickness that may be bent, wrapped or otherwise provided around the receiving portion. The conductive wire 610 may be provided with dimensions x and y such that it may be wrapped around a desired amount of the receiving portion, without forming a complete cylinder such that there is provided a gap 620 between opposing ends of the conductive wire 610. Such a gap 620 avoids an electrical connection/short occurring between the opposing ends of the conducting wire 610.

Such a single turn conductive wire 610 may alternatively define the receiving portion itself, without the need for a separate receiving portion positioned between the conductive wire and the space in which a consumable is to be received. Again, such an embodiment may improve the transfer of heat energy from the conductive wire 110 to aerosolizable material in a received consumable article. Advantageously, by omitting a separate receiving portion, it is possible to reduce the overall thermal mass of the apparatus, which results in faster heating of a consumable article comprising the aerosolizable material that is to be heated.

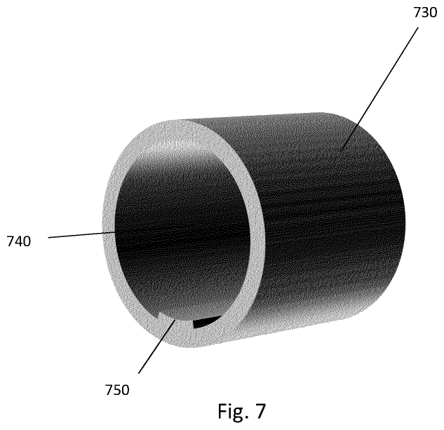

In such a case, a single turn conductive wire may be provided with an external support structure 730 as seen in FIG. 7. In this way the outward facing surfaces of the conductive wire 610 may be supported and/or mounted on an internal surface of the support structure 7300, such that the conductive wire 610 and the support structure 730 form a heating chamber without the need for a separate, thermally conductive, internal support. One such way of retaining the conductive wire 610 in position within the opening 740 in the support structure 730 is to rely on the natural resilience of the conductive wire 610 that biases the wire against the inside of the opening 740 of the support structure 730. Additionally, in order to maintain the gap 620 provided by the single wrap conductive wire 610 when it is bent into position, the support structure may be provided with a protrusion 750, which provides a physical barrier between the opposing ends of the conductive wire 610. Advantageously, such a protrusion may also be utilised as a rest for locating a received consumable article. In this way, the consumable article that has been introduced in through the opening 740 into a receiving portion defined by the conductive wire 610 may be retained so as to not directly contact the conductive wire 610.

In some embodiments, the support structure 730 may be made of a material capable of withstanding temperatures necessary to volatise one or more components of the aerosolizable material. For example, the support structure may be made of a plastics material, and may comprise PEEK. Additionally or alternatively, the support structure may comprise ceramic materials.

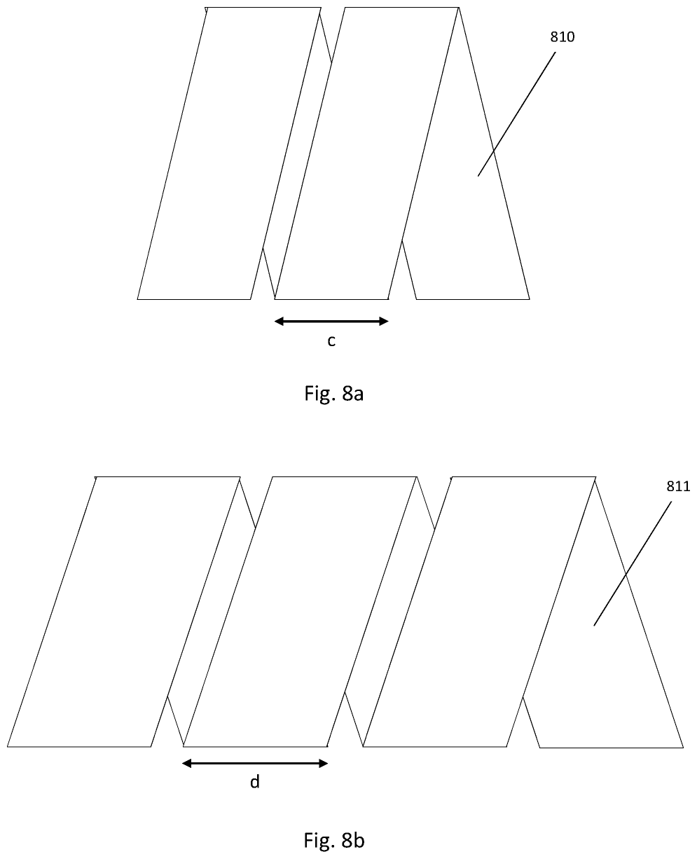

Alternatively, the conductive wire may comprise more than one turn, such as two turns, as seen in conductive wire 810 of FIG. 8a, three turns, as seen in conductive wire 811 of FIG. 8b, or more turns, as seen in FIGS. 1 to 5. When there is provided more than one turn, each turn of the coil is electrically isolated from adjacent turns. In such embodiments, each turn of the coil is separated from adjacent turns by an air gap. In some embodiments, the coil may be encapsulated in a dielectric material.

Conductive wires, such as the ones discussed herein need not necessarily be provided as a substantially cylindrical heater. As would be appreciated, such conductive wires may be able to be used as a flat, planar heater that is configured to heat up a desired planar area.

The conductive wire may be provided with dimensions so as to provide desired heating characteristics, when an electrical current is passed therethrough. Essentially, the rate of heating of the conductive wire is governed by the resistance of the conductive wire, which may be calculated using the following formula:

$$R = ρ \frac{l}{A} \qquad Equation 1$$

Where R is the resistance of the conductive wire, p is the resistivity of the material of the conductive wire, l is the length of the wire and A is the cross sectional area of the wire. For a substantially rectangular cross section of conductive wire, the cross sectional area is given by the thickness of the wire, multiplied by the width of the wire.

Using Equation 1, for a known material with a known resistivity, it is possible to modify the shape and thickness of the conductive wire so as to give a desired resistance, as well as coverage of the conductive wire on an associated area to be heated. For example, it may be desired that the resistance of the conductive wire is around 0.3Ω to provide a desired rate of heating, whilst being operable by a power source of the device. From this, it becomes possible to design the arrangement of a conductive wire.

As would be appreciated, by providing a thinner conductive wire, it is possible to produce a conductive wire with a lower thermal mass, such that the conductive wire heats up faster and provides the quickest subsequent heating of a consumable article positioned therein. However, a thicker conductive wire may be easier to manufacture, and more robust.

Based on these parameters, the conductive wires may be designed so as to provide their desired characteristics. For example, a single turn conductive wire 610 may be provided with desired width and length, a and b, as seen in FIG. 6b, and a desired thickness to provide a given resistance, whilst covering a desired area. The conductive wire of a two turn or three turn configuration may be designed so as to cover a desired area, with using a conductive wire 810, 811 with width of c, or d and a corresponding thickness.

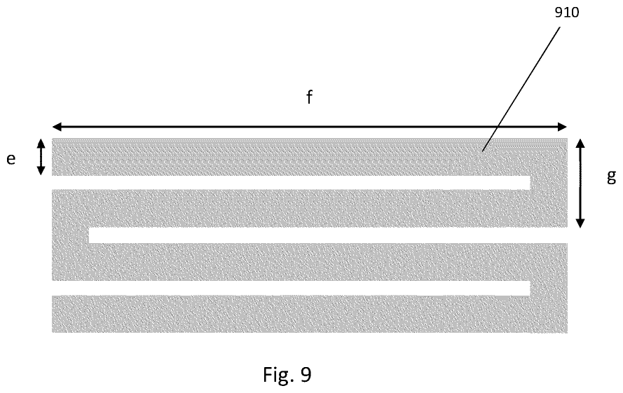

One such way of providing a desired resistivity from a thicker material may be to utilise one or more trace 910, such as one that is seen in FIG. 9. Such an trace(s) may be designed to provide a suitable heating area (or several heating areas) i.e. area of trace, by rearranging Equation 1. For example, it may be desired to heat an area of around 100 mm², for which different dimensions e, f and g may be calculated. Such a conductive wire may be used in a planar heater, or wrapped around a consumable as above.

As above, the conductive wire 110, 610, 810, 811, 911 may formed of a metal material; for example, the conductive wire may include one or more of: aluminium, copper, manganin, steel, constantan, nichrome, stainless steel, nickel and Fecralloy®. In other embodiments, the conductive wire 110, 610, 810, 811, 911 may be formed of a ceramics material. However, it has been found that it may be beneficial to provide a material with a relatively high resistivity for the conductive wires. This allows for reduced geometries of conductive wires to provide a desired resistance, and therefore allows for a shorter, thinner heaters, compared to wires of materials with a lower resistivity. For example, a desired minimum resistivity may be 0.9 ohm·mm²/m. This is particularly beneficial in the field of tobacco heating products, as it allows for the use of smaller consumable articles. Equally, it may be desired that the resistivity is not too high, as it becomes harder to effectively power using a power source. Therefore, a desired maximum resistivity may be 1.6 or 1.5 ohm·mm²/m. A non-exhaustive list materials that fall within this desired range are presented below, in Table 1.

TABLE 1

Material Resistivity

| | ohm/m | ohm · mm²/m |
|---|---|---|
| Fecralloy (RTM) | 1.34E−06 | 1.34 |
| Nichrome | 1.10E−06 | 1.10 |
| Alkrothal (RTM) | 1.20E−06 | 1.20 |
| Kanthal (RTM) | 1.45E−06 | 1.45 |
| Nikrothal (RTM) | 1.09E−06 | 1.09 |

It is also desirable that the thermal coefficient of resistance is as low as possible, meaning that the resistivity of the material does not change depending on temperature. For example, fecralloy may be particularly desirable as its thermal coefficient of resistance is in the order of 0.0001Ω/K.

As would be appreciated, all of the conductive wires above may also be found in an arrangement similar to that of FIG. 5, with multiple heating zones provided by multiple coils. Taking the example of FIG. 5, the first coil 502 and/or the second coil 504 may be provided by a single turn arrangement such as conductive wire 610 of FIG. 6, connected in the same manner as discussed above with regards to FIG. 5. Equally, the first coil 502 and the second coil 504 may be provided by conductive wires with different lengths, numbers of turns, widths and thicknesses, depending on the desired heating profile of their respective heating zones.

When there is provided multiple heating zones, it may be beneficial to provide a receiving portion 1004, 1005 with several different corresponding thermally independent zones HZ1 and HZ2, to prevent heat bleed between the individual zones. For example, a first coil 502 may be provided around HZ1, and a second coil 504 may be provided around HZ2. Length x of HZ1 and length v of HZ2 may be varied such that they correspond to the respective lengths of first coil 502, and second coil 504.

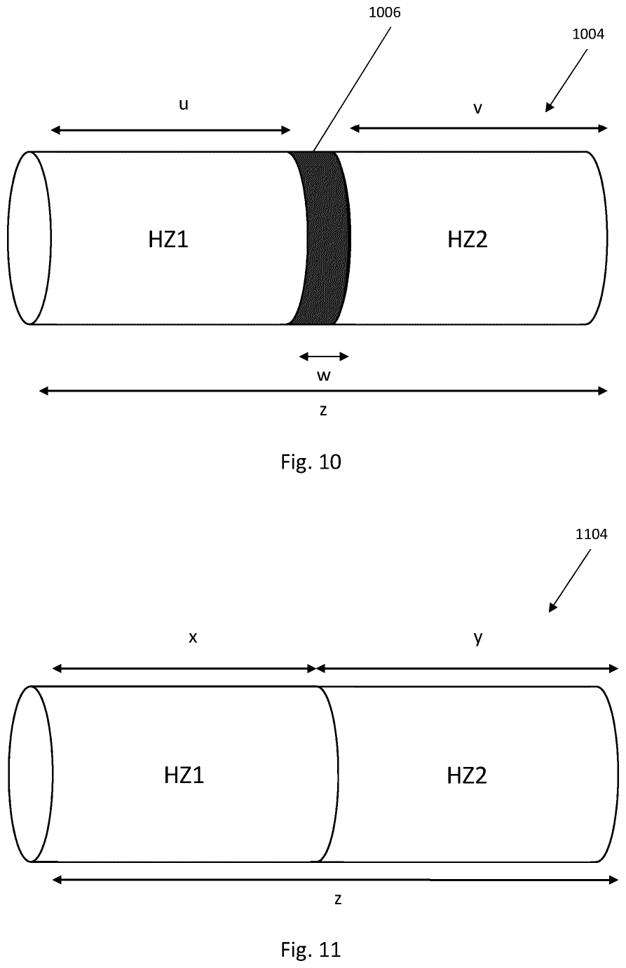

As seen in FIG. 10, HZ1 and HZ2 of receiving portion 1004 may be spaced apart by a heat stop 1006. The heat stop 1006 may be made from a material with a significantly lower thermal conductivity, such that heat may not bleed between HZ1 and HZ2, keeping these zones thermally independent. This allows for the effective creation of two separate heating zones that heat two sections of a consumable article that is provided inside the receiving portion independently. HZ1 and HZ2 may be made out of either the same, or different materials. For example, HZ1 and HZ2 may be made from anodised aluminium, or high carbon steel, whereas the heat stop 1006 may be made from PEEK. The heat stop 1006 should be as thin as possible, whilst still providing relative thermal independence of HZ1 and HZ2. For example, heat stop 1006 may have a width w of 1 mm, which combined with the width u of HZ1, and width v of HZ2, provide a total length z of the receiving portion 1004. HZ1, HZ2 and heat stop 1006 may be provided together by any suitable connection. For example, the heat stop 1006 may be held in place by retaining the positions of HZ1 and HZ2 such that they hold the heat stop 1006 between them in compression. Additionally, or alternatively, there may be a mechanical connection between HZ1, HZ2, and heat stop 1006. Such an arrangement allows for the use of a high thermal conductivity material throughout the receiving portion 1004, and physically stops heat bleed such that fully independent heating zones can be created.

Alternatively, as seen in FIG. 11, HZ1 and HZ2 of receiving portion 1104 may not be spaced apart, and rather they may be provided together. In this embodiment, HZ1 may be provided with a material with a relatively high level of thermal conductance, and HZ2 may be provided with a material of a relatively lower level of thermal conductance. For example, HZ1 may be made of anodized aluminium, whereas HZ2 may be made from a mild steel or a high carbon steel. HZ1 may be provided with width x, and HZ2 may be provided with width y so as to provide a total length z in which a consumable article may be received. In such a case, HZ1 may be designed so as to allowed the fastest time to first puff of a received consumable article with minimal energy usage, whereas HZ2 may be designed to facilitate an independent zone that takes longer to come up to temperature to promote longevity. As would be accepted, as there is no heat stop between HZ1 and HZ2 in receiving portion 1014, there would be a limited amount of heat bleed between these potions, although this would be mitigated by the relative differences in thermal conductivity between HZ1 and HZ2. Again, HZ1 and HZ2 may be connected by any suitable method. For example, HZ1 and HZ2 may simply be held in compression, or alternatively the may be provided with an overlap and then welded, for example, they may be laser welded together. Such an arrangement allows for the entirety of the receiving portion to be used for heating the consumable article that is provided therein.

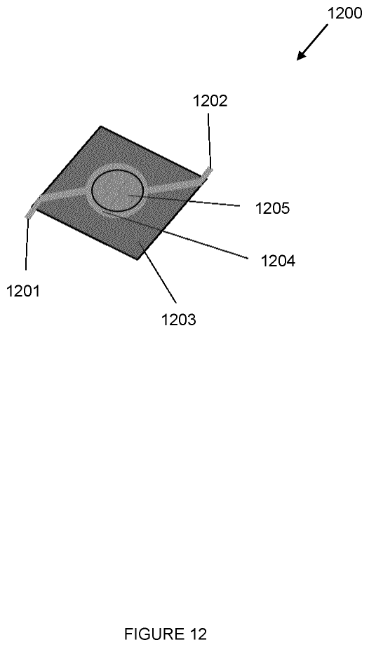

As shown in FIG. 12, a consumable, shown generally as 1200, may be provided for use in a tobacco heating device (not shown). The consumable 1200 may include a trace applied to a backing sheet 1203. The trace, for example, includes material that conducts electrical current when applied to the tobacco heating device (not shown). The trace may include a current inlet 1201, a central portion 1204 and a current outlet 1202. It is envisaged that when the consumable 1200 is applied to a tobacco heating device, the current inlet 1201 and current outlet 1202 would connect with the tobacco heating device such that electrical current may flow through the trace for heating the consumable 1200. The central portion 1204 of the trace may include a planar aerosolizable material 1205 that would be consumed by the user, in use. For example, the aerosolizable material 1205 may be in the form of an aerosolizable gel or compact powder provided on the central portion 1204 of the trace.

In the example shown in FIG. 12, the central portion 1204 of the trace and the aerosolizable material 1205 are a disc shape. However, it is envisaged that any shape, e.g. rectangle, square, triangle, etc. may be used for the consumable 1200. The backing sheet 1203 on which the trace and aerosolizable material 1205 are provided is, as an example, cardboard or paper. Of course, any other material that does not conduct electrical current may be used for the backing sheet 1203.

In the example shown in FIG. 12, there is shown one conductive trace on the consumable. However, it is envisaged that there may be more than one trace that are independently operable and configured to heat portions of the aerosolizable material. In an example, there may be two or more central portions that heat two or more portions of the aerosolizable material. Additionally or alternatively, where there are more than one traces, then each trace may be configured to heat separate, respective portions of aerosolizable material. For example, there may be three disc shaped traces, that heat three corresponding disc shaped portions of aerosolizable material.

The trace (or traces) including the current inlet 1201, the current outlet 1202 and the central portion 1204 may be formed from a metallic material such as aluminium, copper, manganin, steel, constantan, nichrome, stainless steel, nickel and Fecralloy®. In some embodiments, a desired minimum resistivity may be 0.9 ohm·mm²/m. A desired maximum resistivity may be 1.6 or 1.5 ohm·mm²/m. A non-exhaustive list materials that fall within this desired range are presented above, in Table 1.

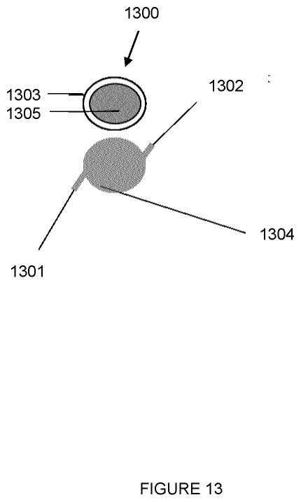

In FIG. 13, an alternative to the consumable 1200 is shown. As shown in FIG. 13, there is provided a trace that includes a current inlet 1301, a current outlet 1302 and a receiving portion 1304 in the tobacco heating device (not shown). A removable consumable 1300 may include a backing sheet 1303 and a planar aerosolizable material 1305 attached to the backing sheet 1303. The receiving portion 1304 of the trace in the tobacco heating device is configured to receive the removable consumable 1300—i.e., the backing sheet 1303 and planar aerosolizable material 1305 are able to be received by the receiving portion 1304 of the trace within the tobacco heating device. Once the removable consumable 1300 is inserted into the tobacco heating device, electric current may flow through the current inlet 1301 to the receiving portion 1304 in order to heat the aerosolizable material 1305 for consumption.

As shown in FIG. 13, the receiving portion 1304 of the trace and the aerosolizable material 1305 may be a disc shape. However, it is envisaged that any shape, e.g. rectangle, square, triangle, etc. may be used for the consumable 1300 or the receiving portion 1304 of the trace. The backing sheet 1303 on which the aerosolizable material 1305 is provided is, as an example, cardboard or paper. Of course, any other material that does not conduct electrical current may be used for the backing sheet 1303.

In the example shown in FIG. 13, there is shown one conductive trace for a tobacco heating device. However, it is envisaged that there may be more than one trace that are independently operable and configured to heat portions of the aerosolizable material. In an example, there may be two or more receiving portions that heat two or more portions of the aerosolizable material.

The trace (or traces) including the current inlet 1301, the current outlet 1302 and the receiving portion 1304 may be formed from a metallic material such as aluminium, copper, manganin, steel, constantan, nichrome, stainless steel, nickel and Fecralloy®. In some embodiments, a desired minimum resistivity may be 0.9 ohm·mm²/m. A desired maximum resistivity may be 1.6 or 1.5 ohm·mm²/m. A non-exhaustive list materials that fall within this desired range are presented above, in Table 1.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus arranged to heat aerosolizable material to volatise at least one component of the aerosolizable material, the apparatus comprising:
a conductive wire arranged to generate heat for transfer to the aerosolizable material in response to application of an electric current, wherein the conductive wire has a resistivity from about 0.9 ohm·mm²/m to about 1.6 ohm·mm²/m.

2. The apparatus of claim 1, wherein the apparatus further comprises:
a receiving portion arranged to receive a consumable article comprising the aerosolizable material, and wherein the conductive wire is disposed around the receiving portion.

3. The apparatus of claim 2, wherein the consumable article is cylindrical, and wherein the receiving portion is a tube arranged to receive the cylindrical consumable article comprising the aerosolizable material.

4. The apparatus of claim 2, wherein the conductive wire is arranged in a helix around the receiving portion.

5. The apparatus of claim 1, wherein the conductive wire comprises two or more zones comprising a first zone and a second zone, the first zone extending from a distal end to an intermediate portion, and the second zone extending from the intermediate portion to a proximal end.

6. The apparatus of claim 1, wherein the apparatus is a consumable article comprising:
a backing sheet, wherein the conductive wire is applied to the backing sheet, and wherein the aerosolizable material is provided on the conductive wire.

7. The apparatus of claim 6, wherein the conductive wire comprises an electric current inlet, a central portion and an electric current outlet.

8. The apparatus of claim 7, wherein the aerosolizable material is provided on the central portion.

9. The apparatus of claim 6, wherein the backing sheet is formed at least in part from card or paper.

10. The apparatus of claim 7, wherein the central portion is a disc shaped, and wherein the aerosolizable material is a disc shaped.

11. The apparatus of claim 1, wherein the conductive wire comprises an electric current inlet, a receiving portion and an electric current outlet.

12. The apparatus of claim 11, wherein the receiving portion is adapted to receive a consumable article comprising the aerosolizable material.

13. The apparatus of claim 11, wherein the receiving portion is disc shaped.

14. The apparatus of claim 1, wherein the conductive wire comprises at least one of fecralloy, nichrome, alkrothal, kanthal and nikrothal.
